(19) United States
(12) Patent Application Publication
(10) Pub. No.: US 2014/0013203 A1
(43) Pub. Date: Jan. 9, 2014

(54) SYSTEMS AND METHODS FOR MODIFYING A WEBSITE WITHOUT A BLINK EFFECT

(71) Applicant: Convert Insights, Inc., Walnut, CA (US)

(72) Inventor: Claudiu Rogoveanu, Walnut, CA (US)

(21) Appl. No.: 13/909,916

(22) Filed: Jun. 4, 2013

Related U.S. Application Data
(60) Provisional application No. 61/669,412, filed on Jul. 9, 2012.

(51) Int. Cl. G06F 17/24

(52) U.S. Cl. CPC G06F 17/24
USPC 715/234

(57) ABSTRACT

Systems and methods for mitigating a blink effect during modification of a webpage, while minimizing delay. In an embodiment, a display of webpage content in a browser application is prevented. Modifications for at least some elements of the webpage content are received. Before one or more elements of the webpage content have loaded, elements to be modified are polled to determine whether they are available for modification. Elements to be modified, which are available for modification, are modified. Once all elements have been modified, the webpage content is displayed in the browser application.

### PRIORITY

This application claims the benefit of U.S. Provisional Patent App. No. 61/669,412, entitled “Systems and Methods for Modifying a Website without a Blink Effect” and filed on Jul. 9, 2012, the entirety of which is hereby incorporated herein by reference as if set forth in full.

### FIELD OF THE INVENTION

The systems and methods disclosed herein relate generally to client-side website modification, and, more particularly, to modifying a webpage prior to a visitor viewing it.

### BACKGROUND

There are a number of contexts in which it is useful to modify a webpage on the client side, i.e., after it has been received by a client application (e.g., browser application) residing on a visitor's system. For example, in multivariate website A/B testing, a website's or webpage's content is modified on the client-side, and the effects of this modification are then measured. For example, a testing tool can be used to replace website content with an alternative version. The original version is then tested with the variant version, for example, to determine which content better advances the defined goals of the website or webpage (e.g., a conversion rate). In multivariate testing, dozens or hundreds of different variations can be mixed on one test.

Website modification can also be useful in the personalization of websites. For example, a webpage may be modified based on a visitor's browsing history and/or preferences. It should be understood that website A/B testing and website personalization are simply two examples. There are numerous other contexts in which website modification may be utilized.

Any portion of a webpage can be changed client-side. Modifications can range from simple heading or color changes to complex layout changes. Typically, this modification or replacement of content occurs within a browser application of a visitor of the webpage, after the webpage has been retrieved by the browser from a web server. Generally, the webpage is modified immediately after it is loaded inside a visitor's client-side browser application. However, this can create a “blink” effect, in which the visitor initially sees the original, unmodified webpage, and then sees the modified webpage. In addition to ruining the visitor's experience, blink effects can also influence the website A/B testing (e.g., by affecting the visitor's perception or experience of the webpage), and thus reduce the accuracy and/or validity of the testing.

This blink effect can be mitigated by initially hiding a webpage as it is loading and being modified, and then displaying the webpage only after the modifications have been completed. Conventional testing tools hide the entire webpage for an amount of time sufficient to complete modification of the content.

A webpage, according to Hypertext Markup Language (HTML), generally comprises a HEAD and BODY section. The HEAD section is generally identified by being book-ended between an opening “<head>” tag and a closing “</head>” tag. Likewise, the BODY section is identified by “<body>” and “</body>” tags. Scripts (e.g., JavaScript) can also be included in the webpage, for example, by using “<script>” and “</script>” tags. At a point where JavaScript code is inserted into a HEAD section, a Cascading Style Sheet (CSS) code can be automatically inserted to hide all or a portion of a webpage's content by hiding the “<body>” element. For example, this can be done by setting or altering a display attribute associated with the BODY section, such that the content of the BODY section is not displayed or is hidden. Once the webpage has been loaded and modified or a timer has expired, this attribute can be altered in order to display the content of the BODY section in the visitor's browser application.

The Document Object Model (DOM) is a cross-platform and language-independent convention for representing and interacting with objects in HTML, Extensible Hypertext Markup Language (XHTML), and Extensible Markup Language (XML). When an HTML, XHTML, or XML page is rendered in a browser application, the browser application parses the markup (e.g., downloaded from a web server) into an in-memory DOM. The DOM is used to construct additional internal structures used to display the page in the browser window. The nodes of every document are organized in a tree structure, called a DOM tree. The topmost node in the DOM tree is the Document object, and each node has zero or more children.

By web standards, elements of the webpage can be modified only after a DOM-ready event, i.e., after the webpage's DOM tree, defining each of the elements of the webpage, has been fully initialized. Accordingly, even if the desired modifications are only to a few elements of the webpage, none of the modifications can occur until every element of the webpage has been loaded. Furthermore, some browser applications only trigger DOM-readiness after all CSS resources and scripts are loaded, increasing the amount of time before modifications can be implemented. If a webpage has a very slow CSS resource (e.g., in the footer of the webpage) that takes ten seconds to load, then DOM-readiness will also be delayed by ten seconds. Consequently, modification and display of the content in the BODY section of the webpage will also be delayed by the same amount of time. As the delay increases, the amount of time that the visitor sees an empty screen in his or her browser application also increases. Consequently, longer delays result in less satisfying experiences for visitors to a webpage.

### SUMMARY

Accordingly, systems and methods are disclosed for eliminating the blink effect associated with client-side website modification, while reducing the amount of delay required in order to avoid the blink effect, by optimizing or minimizing the amount of time that the BODY section of a webpage is hidden.

In an embodiment, a method for mitigating a blink effect during modification of a webpage is disclosed. The method comprises, by at least one hardware processor, preventing the display of a content of a webpage, the content comprising a plurality of elements; receiving one or more modifications for the webpage, wherein the modifications are associated with a subset of one or more of the plurality of elements; before one or more of the plurality of elements have been loaded, polling the subset of elements to determine whether one or more of the subset of elements is available for modification; if it is determined that one or more of the subset of elements is available for modification, modifying the one or more of the subset of elements available for modification; determining whether all of the subset of elements have been modified; and, if it is determined that all of the subset of elements have been modified, displaying the content of the webpage.

In an additional embodiment, a non-transitory computer-readable medium is disclosed. The non-transitory computer-readable medium stores instructions that, when executed by at least one hardware processor, prevent the display of a content of a webpage, the content comprising a plurality of elements; receive one or more modifications for the webpage, wherein the modifications are associated with a subset of one or more of the plurality of elements; before one or more of the plurality of elements have been loaded, poll the subset of elements to determine whether one or more of the subset of elements is available for modification; if it is determined that one or more of the subset of elements is available for modification, modify the one or more of the subset of elements available for modification; determine whether all of the subset of elements have been modified; and, if it is determined that all of the subset of elements have been modified, display the content of the webpage.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example method for mitigating blink effects, while minimizing delays, in accordance with an embodiment; and

FIG. 2 is an illustration of an example computing device which can be used in conjunction with the disclosed systems and processes, according to an embodiment.

### DETAILED DESCRIPTION

As discussed above, a JavaScript code or CSS code can be automatically inserted into the HEAD section of a webpage being tested to hide the BODY section of the webpage until test-related modifications to elements of the webpage have been completed.

In an embodiment, a JavaScript or other code snippet is also inserted into the HEAD section of a webpage being modified to load an external resource in an asynchronous mode (i.e., while the webpage is loading). The external resource may be external from the browser application, and may be remote from the device executing the browser application. For instance, the external resource may be retrieved from a server via one or more networks, including the Internet. The external resource makes available the modifications that need to be made to the webpage in a browser application of the visitor of the webpage. Alternatively or additionally, one or more modifications may be embedded within the webpage itself, e.g., as a series of functions and/or a list of CSS/jQuery selectors that identify one or more elements and the modifications (e.g., content) to be applied to those elements. In either case, whether contained in an external resource or embedded directly within the webpage, the modifications may comprise one or more scripts. For example, the modifications may comprise JavaScript code that uses the jQuery library for accessing and changing block elements in the webpage. The jQuery Library is an open-source cross-browser JavaScript library designed to simplify the client-side scripting of HTML.

At the same time as the BODY section of the webpage is hidden, and while the external resource is being loaded (for embodiments which utilize an external resource), a timer can be started to count the milliseconds (or other unit of time) that have elapsed since the BODY section was hidden. The timer is defined for keeping the BODY section of the webpage hidden. A person of skill in the art will appreciate that the timer may count down from a predetermined number to zero, or count up from zero to a predetermined threshold.

According to an alternative embodiment, there are two moments at which the BODY section can be unhidden (i.e., displayed in the visitor's browser application):
(1) at the moment when the timer times out (i.e., reaches zero or the predetermined threshold); or
(2) at the moment that the modifications to the webpage are completed. Once all modifications are completed, there is no need to continue hiding the BODY section of the webpage, since no further modifications will be performed, and thus, no flicker or blink effect will occur. In one embodiment, the modifications are not performed until a DOM-ready event occurs. In an alternative embodiment, discussed in detail below, elements can be modified prior to a DOM-ready event. In this embodiment, the first embodiment (i.e., performing modification only after the occurrence of the DOM-ready event) can be used as a fall-back process for browser applications which do not support modifications of elements prior to the occurrence of the DOM-ready event.

In an embodiment, the webpage is displayed (i.e., unhidden) at the time that either of these moments occur. For example, if the timer times out but the modifications are not completed, the webpage is displayed, even though a blink effect may occur. Conversely, if the modifications are completed but the timer has not timed out, the webpage is displayed, and no blink effect will occur.

In the above embodiment, if the modifications are not performed until a DOM-ready event occurs and the set timeout for the timer is smaller than the time needed for a DOM-ready event to occur, then the BODY section of the webpage will already be shown. In other words, the timer will time out, and the BODY section will be displayed prior to the occurrence of the DOM-ready event. Consequently, since the modifications will not occur until after the DOM-ready event, which is after the BODY section has been displayed, a blink effect will be visible in the visitor's browser application.

Advantageously, in an alternative embodiment, the modification to the webpage can be commenced, and potentially completed, prior to every element of the webpage being loaded. In this embodiment, a polling mechanism can be used. This polling mechanism can be initiated once the external resource comprising the modifications has been loaded. Alternatively, the polling mechanism can be initiated once a usable portion of the external resource (e.g., a portion comprising one or more usable modifications) has been loaded, but before the entire external resource has been loaded.

In an embodiment, the polling mechanism checks every X milliseconds (or other unit of time) whether one or more elements needing or desired to be modified have been loaded in the webpage. X may be an integer, or any other number. If the polling mechanism detects that an element to be modified has been loaded, the element can then be modified according to the associated modification of the external resource. The polling mechanism may continue polling elements, which are identified in the external resource as needing to be modified, until all identified elements to be modified have been detected and modified. In an embodiment, once the polling mechanism detects an element to be modified, it no longer attempts to poll that element. Once all of the elements to be modified have been detected and modified, the polling stops, and the BODY section of the webpage can be displayed, for example, by changing a display attribute associated with the BODY section to visible.

In an embodiment, the polling mechanism can comprise a background script, such as a JavaScript that attempts to access an element, for example, through a DOM tree, even if the DOM tree has not been fully initialized. The background script can perform the attempts to access elements every X milliseconds to check whether the elements are accessible. The script may also be implemented to determine which elements are accessible and which elements are not yet accessible. For example, Sizzle Engine for the jQuery Library provides scripting for locating elements on a webpage. Alternatively, plain JavaScript can be used. For example, native JavaScript methods, such as getElementByld( ) or getElementsByTagName( ) can be used to attempt to retrieve the desired element. If the method returns an element, the element can then be modified. However, if the method returns a null value, then it can be determined that the element is not yet available, and polling of the element can continue.

By way of illustration only, an example polling test, utilizing the jQuery Library, could comprise an IF statement, such as:

if( jQuery(‘#my_id”).length >= 1) {
// Perform modification to element identified by #my_id
}

Using the above-described polling mechanism, any delays in the DOM-ready event do not delay the modifications to the elements of the webpage. For example, even if a slow resource in the footer of a webpage delays the DOM-ready event, elements of the webpage can still be modified without having to wait for the DOM-ready event. In this manner, delays are minimized, and the BODY contents can be unhidden (i.e., displayed) much faster than in conventional systems, while avoiding flicker or blink effects.

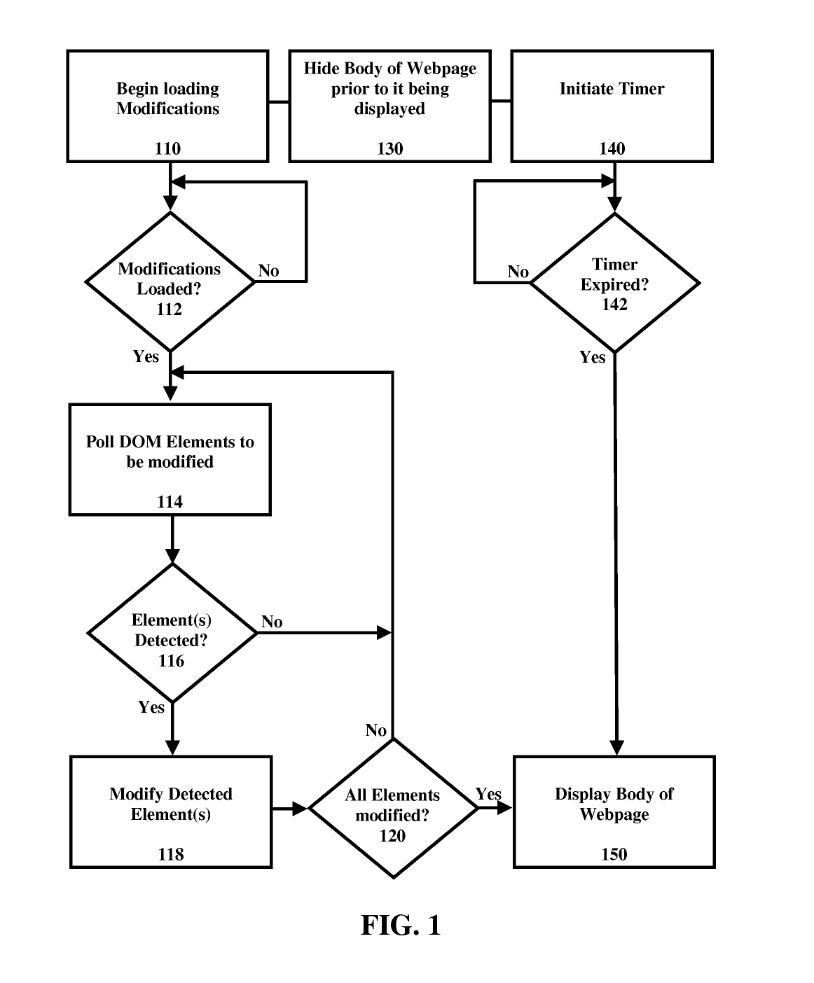

FIG. 1 illustrates one method for mitigating blink effects, while minimizing delays, in accordance with an embodiment. Initially, in step 130, in order to prevent the blink effect, the body of a webpage is hidden prior to being displayed. This may be done via a CSS code place in the HEAD section of the webpage. As the visitor will not see the original webpage (i.e., without modification), no flicker or blink effect will be visible to the visitor. In other words, the visitor will only see the final, modified webpage.

At or near the same time as step 130, in step 110, variation content or a resource, which may be an external resource, comprising the modifications for the webpage, is loaded. In addition, at or near the same time as steps 110 and 130, a timer is initiated in step 140.

In step 112, it is determined whether one or more of the modifications have loaded. If not, the process continues to check whether the modifications have loaded. If the modification(s) have been loaded, the process continues to step 114, where DOM elements associated with the loaded modifications are polled. This polling may be periodic, according to a polling timer. For example, the polling mechanism may check every X milliseconds for the webpage elements that are desired to be modified and/or identified in the external resource. It should be noted that the polling timer is different than the timer in step 140. Alternatively, the polling may be in response to a triggering event, such as a determination, in step 120, that there still exist elements to be modified.

In an embodiment, the polling starts when the variation content or external resource is loaded and ends at the earlier of: (1) completion of modifications to all elements to be modified; and (2) the triggering of the DOM-ready event. For example, if the DOM-ready event occurs prior to all modifications being completed, the polling mechanism can end, and the modifications can proceed for all elements remaining to be modified.

In step 116, based on the results of the polling in step 114, it is determined whether an element (e.g., DOM element) to be modified has been loaded. If no element is detected, the process continues the polling process in step 114. If an element is detected, the loaded element is modified in step 118.

In step 120, it is determined whether all elements identified by the modifications have been modified. If not, the process continues polling according to step 114. However, if it is determined that all identified elements have been modified, the process continues to step 150, in which the body of the webpage is displayed in the browser application.

In parallel with steps 112-120, the timer initiated in step 140 counts up or down towards a time-out condition (e.g., reaching zero). Once the timer times out, the process proceeds to step 150, in which the body of the webpage is displayed in the browser application.

It should be understood that the embodiment described with reference to FIG. 1 is merely illustrative, and that one or more steps may be omitted without departing from the spirit or scope of the invention. For instance, the timer that is the subject of steps 140 and 142 may be omitted entirely. Furthermore, some browser applications may not support the polling method described above. In this case, the process may wait until the DOM-ready event before performing the modifications to the elements.

Notably, in certain embodiments of the disclosed systems and methods, it has been found that the disclosed systems and methods result in webpages being displayed 50%-70% faster than in conventional systems and methods.

Detecting or verifying elements of a webpage before a DOM-ready event is not a behavior documented by general web standards. Thus, in a sense, the disclosed polling mechanism is a “hack” that allows modifications of content of a webpage prior to the webpage being fully loaded and displayed. As a non-hack alternative to the disclosed polling system, in one embodiment, a browser application could make events available that would allow manipulation of a webpage's content prior to the webpage being fully loaded or displayed.

For example, an “onBeforeLoad” event can be provided which is triggered before an element is rendered in the browser application, and which makes the object available for modifications. In addition, an “onAfterLoad” event can be provided which is triggered immediately after an element is rendered, and which makes the object available for modifications. In such an embodiment, the modifications can be derived, as described above, as either an external resource that is loaded or code that is embedded in a webpage itself, e.g., as a list of CSS/jQuery selectors that identify one or more elements and the modifications (e.g., content) to be applied to those elements. In either case, the function of loading the external resource or the list of elements and modifications can be embedded in the HEAD section of the webpage. In addition, a script can be embedded in the webpage to bind one or more functions (e.g., from an external resource or embedded code), corresponding to the modifications of the elements to be modified in the webpage, to the “onBeforeLoad” and/or “onAfterLoad” events. This script may be written, for example, in JavaScript and embedded in the HEAD section of the webpage. However, it should be understood that the script may be written in any appropriate programming language, and may be embedded in any portion of the webpage or, alternatively, contained in an external resource referenced by the webpage.

In an embodiment, if a function is bound to the “onBeforeLoad” event, the function will be executed before the corresponding element is loaded into the webpage. Thus, prior to the element being loaded into the webpage, the function can retrieve a reference to the element and modify the element, for example, by altering its contents. In a further embodiment, the “onBeforeLoad” event can occur prior to the element being defined in the DOM tree. In such an embodiment, the DOM tree may only ever comprise the modified version of the element, and never comprise the unmodified version.

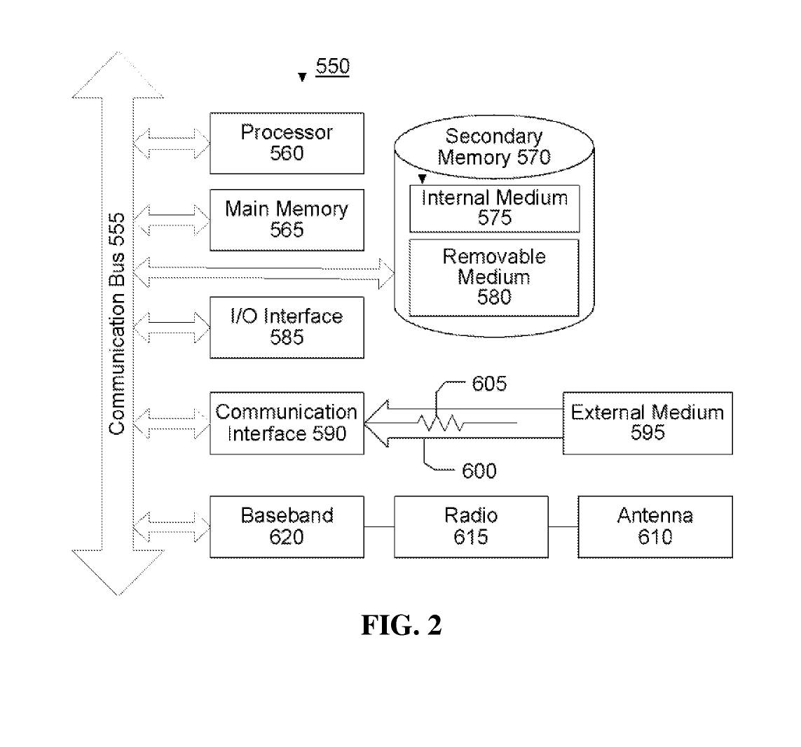

FIG. 2 is a block diagram illustrating an example wired or wireless system 550 that may be used in connection with various embodiments described herein. For example the system 550 may be used as or in conjunction with one or more of the mechanisms and processes previously described above. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560, such as one or more of the modules discussed above. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A method for mitigating a blink effect during modification of a webpage, the method comprising, by at least one hardware processor:
preventing the display of a content of a webpage, the content comprising a plurality of elements;
receiving one or more modifications for the webpage, wherein the modifications are associated with a subset of one or more of the plurality of elements;
before one or more of the plurality of elements have been loaded, polling the subset of elements to determine whether one or more of the subset of elements is available for modification;
if it is determined that one or more of the subset of elements is available for modification, modifying the one or more of the subset of elements available for modification;
determining whether all of the subset of elements have been modified; and, if it is determined that all of the subset of elements have been modified, displaying the content of the webpage.

2. The method of claim 1, further comprising:
initiating a timer;
determining whether the timer has expired; and,
if it is determined that the timer has expired, displaying the content of the webpage.

3. The method of claim 1, wherein preventing the display of a content of a webpage comprises altering an attribute of the content prior to the webpage being displayed in a browser application.

4. The method of claim 1, wherein receiving one or more modifications for the webpage comprises receiving at least a portion of an external resource comprising the one or more modifications.

5. The method of claim 4, wherein receiving at least a portion of an external resource comprises receiving the at least a portion of the external resource via at least one network.

6. The method of claim 1, further comprising:
determining whether polling the subset of elements before one or more of the plurality of elements have been loaded is not supported by a browser application; and,
if it is determined that polling the subset of elements is not supported by the browser application, waiting for a ready event before modifying the subset of elements.

7. The method of claim 6, wherein the ready event is a Document Object Model (DOM) ready event.

8. The method of claim 1, wherein polling the subset of elements comprises periodically polling the subset of elements.

9. The method of claim 1, wherein polling the subset of elements comprises executing one or more scripts that attempt to access the subset of elements.

10. The method of claim 1, wherein the plurality of elements comprise a plurality of Document Object Model (DOM) objects.

11. A non-transitory computer-readable medium storing instructions that, when executed by at least one hardware processor:
prevent the display of a content of a webpage, the content comprising a plurality of elements;
receive one or more modifications for the webpage, wherein the modifications are associated with a subset of one or more of the plurality of elements;
before one or more of the plurality of elements have been loaded, poll the subset of elements to determine whether one or more of the subset of elements is available for modification;
if it is determined that one or more of the subset of elements is available for modification, modify the one or more of the subset of elements available for modification;
determine whether all of the subset of elements have been modified; and,
if it is determined that all of the subset of elements have been modified, display the content of the webpage.

12. The non-transitory computer-readable medium of claim 11, wherein the instructions further:
initiate a timer;
determine whether the timer has expired; and,
if it is determined that the timer has expired, display the content of the webpage.

13. The non-transitory computer-readable medium of claim 11, wherein preventing the display of a content of a webpage comprises altering an attribute of the content prior to the webpage being displayed in a browser application.

14. The non-transitory computer-readable medium of claim 11, wherein receiving one or more modifications for the webpage comprises receiving at least a portion of an external resource comprising the one or more modifications.

15. The non-transitory computer-readable medium of claim 14, wherein receiving at least a portion of an external resource comprises receiving the at least a portion of the external resource via at least one network.

16. The non-transitory computer-readable medium of claim 1, wherein the instructions further
determine whether polling the subset of elements before one or more of the plurality of elements have been loaded is not supported by a browser application; and,
if it is determined that polling the subset of elements is not supported by the browser application, wait for a ready event before modifying the subset of elements.

17. The non-transitory computer-readable medium of claim 16, wherein the ready event is a Document Object Model (DOM) ready event.

18. The non-transitory computer-readable medium of claim 11, wherein polling the subset of elements comprises periodically polling the subset of elements.

19. The non-transitory computer-readable medium of claim 11, wherein polling the subset of elements comprises executing one or more scripts that attempt to access the subset of elements.

20. The non-transitory computer-readable medium of claim 11, wherein the plurality of elements comprise a plurality of Document Object Model (DOM) objects.
